(19) United States
(12) Patent Application Publication
(10) Pub. No.: US 2026/0259301 A1
(43) Pub. Date: Sep. 3, 2026

(54) FREQUENCY AND TIMING OFFSET ESTIMATION IN BISTATIC RADAR

(71) Applicants: GM GLOBAL TECHNOLOGY OPERATIONS LLC, Detroit, MI (US); University of Southern California, Los Angeles, CA (US)

(72) Inventors: Kamran Ali, Troy, MI (US); Nikhil Kowshika Nataraja, Los Angeles, CA (US); Andreas Molisch, Los Angeles, CA (US)

(73) Assignees: GM GLOBAL TECHNOLOGY OPERATIONS LLC, Detroit, MI (US); University of Southern California, Los Angeles, CA (US)

(21) Appl. No.: 19/067,245

(22) Filed: Feb. 28, 2025

(51) Int. Cl. G01S 7/295; G01S 7/288; G01S 13/00; G01S 13/524; G01S 13/58; G01S 13/931

(52) U.S. Cl. CPC G01S 7/295; G01S 7/2883; G01S 13/003; G01S 13/5244; G01S 13/582; G01S 13/931; G01S 2013/9318

(57) ABSTRACT

A method of determining a frequency offset and a timing offset for a multipath signal in a bistatic radar including receiving a first electromagnetic signal including a data indicative of a transmitter location, extracting an observed multipath component from the first electromagnetic signal and for generating an observed frequency and an observed timing for the multipath component, determining a plurality of reflector locations in response to a map data, the transmitter location and the receiver location, performing a ray tracing algorithm in response to the virtual anchor reflector locations, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing.

### INTRODUCTION

The present disclosure generally relates to automotive electrical systems and vehicle sensor systems, and more particularly relates to a method and apparatus for bistatic radar detection system for a vehicle for estimating a Doppler shift and a time delay of objects located in an environment surrounding the vehicle based on multi-carrier modulation signals that comply with a wireless communication standard.

Radar-based object detection systems are commonly implemented in modern vehicles for environmental scanning and situational awareness. These systems determine object velocity and trajectory. Radar architectures are categorized as monostatic, bistatic, or multi-static. A monostatic radar system integrates the transmitter and receiver within a single physical location. Conversely, a bistatic system spatially separates the transmitter and receiver. A multi-static radar system comprises multiple spatially diverse monostatic or bistatic components, each contributing to a common coverage area.

Bistatic radar systems offer unique advantages, and addressing the inherent timing and frequency offsets between transmitter and receiver clocks is key to optimal performance. Advanced synchronization techniques enable robust background subtraction and precise range-Doppler estimation, leading to improved target detection. While traditional synchronization methods like cabled connections and global navigation satellite system based solutions can be used in some deployments, innovative approaches are being explored for other synchronization methods. Non-Line-of-Sight environments, such as urban areas where multipath propagation from reflective surfaces like buildings, present an opportunity for developing robust synchronization strategies to enhance the performance and applicability of bistatic radar in complex operational scenarios. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle sensor methods and systems and related electrical systems for detecting objects within an area proximate to a vehicle, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for combining map-based reflector localization using multi-modal HD map data and clutter suppression techniques to isolate clock synchronization and moving target effects in order to mitigate timing and frequency synchronization offsets in non-line-of-sight bistatic automotive radar.

In accordance with an aspect of the present disclosure, a radar receiver including some or all of the following: a memory configured to store a map data, a location configured to determine a receiver location and a receiver velocity, a receiver configured to receive a first electromagnetic signal including a data indicative of a transmitter identification, a signal processor configured to extract an observed multipath component from the first electromagnetic signal and for generating an observed frequency and an observed timing for the observed multipath component, a numerical processor configured for performing a ray tracing algorithm in response to the map data, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing, wherein the receiver is further operative to detect a location of a dynamic object and a velocity of the dynamic object in response to the transmitter location, the receiver location, the receiver velocity, the frequency offset, the timing offset and the map data, and a vehicle controller configured to generate a motion path in response to the location of the dynamic object and the velocity of the dynamic object and for controlling a vehicle along the motion path.

In accordance with another aspect of the present disclosure, wherein the location sensor is a global navigation satellite system sensor.

In accordance with another aspect of the present disclosure, wherein at least one of the plurality of virtual anchor reflector locations are determined as a function of a building wall location included in the map data.

In accordance with another aspect of the present disclosure, wherein the dynamic object is a proximate vehicle and wherein the location of the proximate vehicle is determined in response to the proximate vehicle being located on a road surface as defined by the map data.

In accordance with another aspect of the present disclosure, wherein the transmitter identification is indicative of a transmitter and wherein the transmitter is a cellular base station and wherein the first electromagnetic signal and the subsequent electromagnetic signal are cellular communication signals.

In accordance with another aspect of the present disclosure, wherein the numerical processor is further operative to determine an angle of arrival of the first electromagnetic signal in response to the first electromagnetic signal received at a first antenna at a first location on the vehicle and the first electromagnetic signal received at a second antenna at a second location on the vehicle that might be the same of different from the first location of the vehicle.

In accordance with another aspect of the present disclosure, wherein the expected multipath component(s) includes an expected Doppler shift, which might be different for different multipath components.

In accordance with another aspect of the present disclosure, wherein the observed multipath component includes an observed Doppler shift.

In accordance with another aspect of the present disclosure, wherein the transmitter identification includes the transmitter location.

In accordance with another aspect of the present disclosure, a method of controlling a radar receiver including storing, in a memory, a map data including a transmitter location, determining, by a location sensor, a receiver location and a receiver velocity, receiving, by an antenna, a first electromagnetic signal including a data indicative of the transmitter location, extracting, by a signal processor, an observed multipath component from the first electromagnetic signal and for generating an observed frequency and an observed timing for the observed multipath component, determining, by a numerical processor, a plurality of virtual anchor reflector locations in response to the map data, the transmitter location and the receiver location, performing, by the numerical processor, a ray tracing algorithm in response to the plurality of virtual anchor reflector locations, the transmitter location and the receiver location to extract an expected multipath component having an expected frequency and an expected delay and for determining a frequency offset in response to a difference between the expected frequency and the observed frequency and a timing offset in response to a difference between the expected timing and the observed timing, receiving, by the antenna; a subsequent electromagnetic signal having a subsequent timing and a subsequent frequency, determining, by the numerical processor, a location of a dynamic object and a velocity of the dynamic object in response to the transmitter location, the receiver location, the receiver velocity, the subsequent frequency, the subsequent timing, the frequency offset, the timing offset and the map data, and generating, by a vehicle controller, a motion path in response to the location of the dynamic object and the velocity of the dynamic object and for controlling a vehicle along the motion path.

In accordance with another aspect of the present disclosure, wherein the motion path is further generated in response to the map data.

In accordance with another aspect of the present disclosure, wherein the numerical processor is a digital signal processor.

In accordance with another aspect of the present disclosure, wherein the plurality of reflector locations are determined in response to a combination of ray tracing techniques, specular reflection, and machine learning algorithms trained with ray tracing data and measurements of intersections and corresponding reflector locations.

In accordance with another aspect of the present disclosure, including performing a timing drift correction due to the frequency offset by the signal processor.

In accordance with another aspect of the present disclosure, wherein the extracting of the observed multipath component further includes using at least one of a Fourier estimation and a super-resolution algorithm.

In accordance with another aspect of the present disclosure, wherein the observed frequency and the observed timing for the observed multipath component are extracted in response to the observed multipath component exceeding a threshold magnitude.

In accordance with another aspect of the present disclosure, wherein the antenna is an antenna array having a first antenna element and a second antenna element and wherein the signal processor is further configured to determine an angle of arrival of the first electromagnetic signal in response to the first electromagnetic signal received at the first antenna element and a second phase of the first electromagnetic signal received at the second antenna element.

In accordance with another aspect of the present disclosure, including performing a clutter suppression technique on the first electromagnetic signal and a subsequent electromagnetic signal received at a plurality of antennas over a plurality of times.

In accordance with another aspect of the present disclosure, a vehicle including a radar receiver configured for storing, in a memory, a map data including a transmitter location, determining, by a location sensor, a receiver location and a receiver velocity, receiving, by an antenna, a first electromagnetic signal including a data indicative of the transmitter location, extracting, by a signal processor, an observed multipath component from the first electromagnetic signal and for generating an observed frequency and an observed timing for the observed multipath component, determining, by a numerical processor, a plurality of virtual anchor reflector locations in response to the map data, the transmitter location and the receiver location, performing, by the numerical processor, a ray tracing algorithm in response to the plurality of virtual anchor reflector locations, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing, receiving, by the antenna; a subsequent electromagnetic signal having a subsequent timing and a subsequent frequency, determining, by the numerical processor, a location of a dynamic object and a velocity of the dynamic object in response to the transmitter location, the receiver location, the receiver velocity, the subsequent frequency, the subsequent timing, the frequency offset, the timing offset and the map data, and a vehicle controller configured for generating a motion path in response to the location of the dynamic object and the velocity of the dynamic object and controlling the vehicle along the motion path.

In accordance with another aspect of the present disclosure, wherein the antenna is an antenna array having a first antenna element and a second antenna element and wherein the signal processor is further configured to determine an angle of arrival of the first electromagnetic signal in response to the first phase of the first electromagnetic signal received at the first antenna element and a second phase of the first electromagnetic signal received at the second antenna element, and for performing a displaced phase center antenna clutter suppression technique on the first electromagnetic signal received at the first antenna element and the first electromagnetic signal received at the second antenna element.

### BRIEF DESCRIPTION OF THE DRAWINGS

The exemplary embodiments will hereinafter be described in conjunction with the following drawing figures, wherein like numerals denote like elements, and wherein:

FIG. 1 shows a control system associated with a vehicle in accordance with various embodiments;

FIG. 2 shows an exemplary environment for use of a vehicle having a system for performing frequency and timing offset estimation in bistatic radar in accordance with various embodiments;

FIG. 3 shows a functional block diagram illustrative of a system for performing frequency and timing offset estimation in bistatic radar in accordance with various embodiments;

FIG. 4 shows a graph illustrative of a frequency and timing offset estimation in bistatic radar in accordance with various embodiments; and

FIG. 5 shows a flow chart illustrative of a method for performing frequency and timing offset estimation in bistatic radar in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

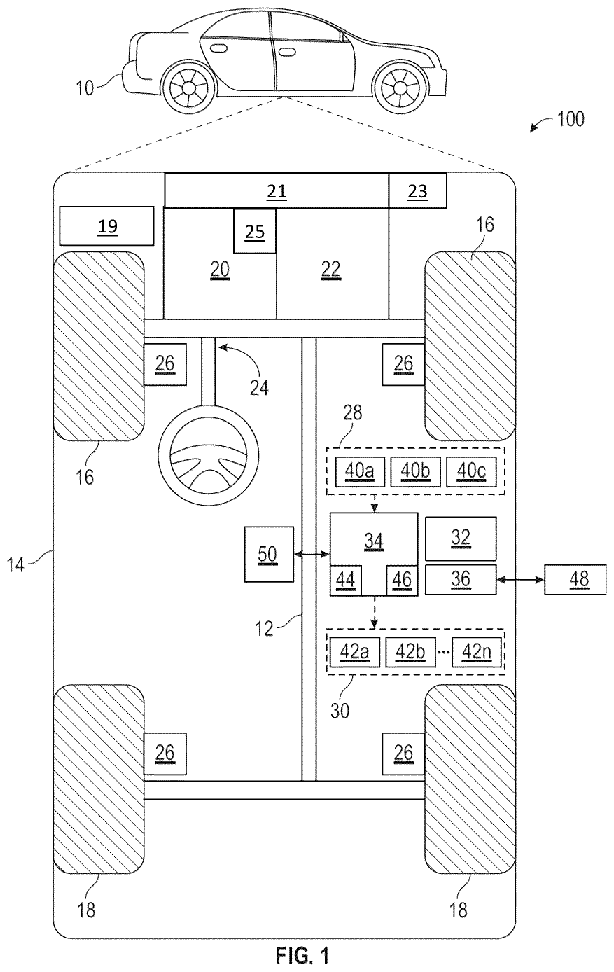

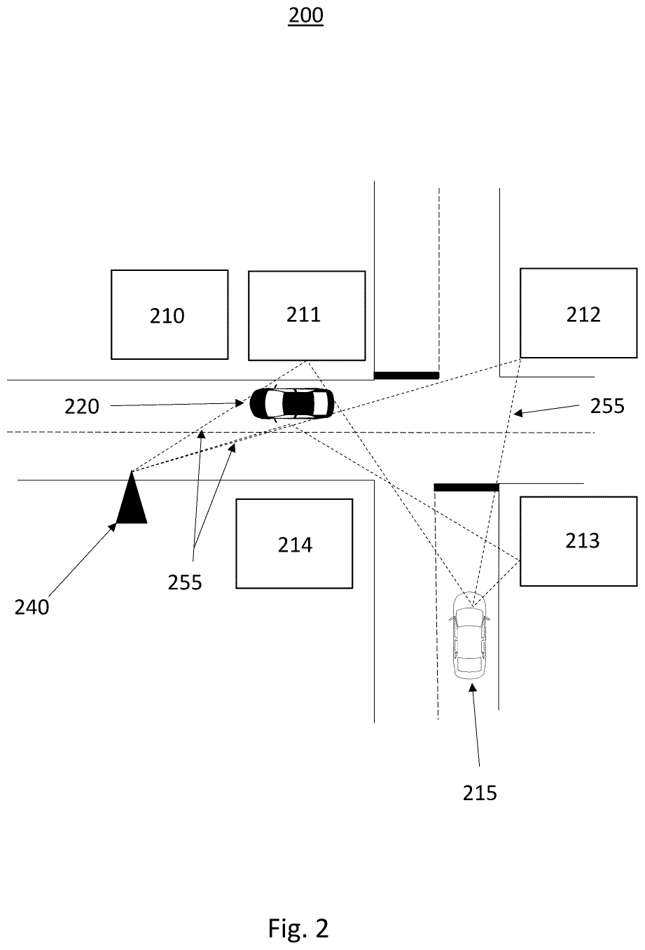

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., torque control) established by Reinforcement Learning (RL) which is or can be stored in a deep neural network (DNN) type model that controls operation in response to data from vehicle inputs, for example, as described in greater detail further below in connection with FIGS. 2-4.

In various exemplary embodiments, system 100 provides a process using an algorithm that controls torque and speed in a host vehicle's 10 embedded controller software of the system 100 allowing DNN to be used for an automated cruise control behavior prediction model. The system 100 enables learning of driver's preference for following distance for different vehicles such a target vehicle and to classify driver's preference based on driving scenarios; e.g., traffic signs, stop and go traffic, city driving, and the like. The system 100 uses a quadrature matrix to build a knowledge base for target vehicles following a performance preference by utilizing online and historical driver and environmental information.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles, recreational vehicles, marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, an electric machine such as a traction motor 25, a battery 21, an inverter 19 for converting direct current (DC) from the battery to alternating current (AC) current to be supplied to the electric machine, and an on board charger 23 for converting AC current from an external power source to a DC current to be used to charge the battery 21. In some exemplary embodiments, the traction motor 25 can be a permanent magnet synchronous motor (PMSM), The transmission system 22 is configured to transmit power from the propulsion system 20 to the vehicle wheels 16 and 18 according to selectable speed ratios. According to various embodiments, the transmission system 22 may include a step-ratio automatic transmission, a continuously variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 1).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10, including the storing of data of a DNN that is established by the RL, used to predict a driver behavior for the vehicle control. In various embodiments, the data storage device 32 stores a machine learning model of a DNN and other data models established by the RL. The model established by the RL can take place for a DNN behavior prediction model or RL established model (See. FIG. 2, DNN prediction model or RL prediction model). In an exemplary embodiment, no separate training is required for the DNN rather, the DNN behavior prediction model (i.e., DNN prediction model) is implemented with a set of learned functions. In various embodiments, the neural network (i.e., DNN behavior prediction model) may be established by RL or trained by a supervised learning methodology by a remote system and communicated or provisioned in vehicle 10 (wirelessly and/or in a wired manner) and stored in the data storage device 32. The DNN behavior prediction model can also be trained via supervised or unsupervised learning based on input vehicle data of a host vehicle operations and/or sensed data about a host vehicles operating environment.

The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 implements the logic model established by reinforced learning (RL) or for the DNN based on the DNN behavior model that has been trained with a set of values, including at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other, infrastructure, remote transportation systems, and/or user devices (described in more detail with regard to FIG. 2). In an exemplary embodiment, the communication system 36 is a wireless communication system configured to communicate via a wireless communications network, such as a 5G cellular communications network. Cellular communication networks, especially those utilizing 5G, provide wireless connectivity to mobile devices by employing a system of cell sites that transmit and receive radio waves, enabling these mobile devices to communicate with each other and other communications networks. However, additional or alternate communication methods, such as a wireless local area networks (WLAN) using wireless network protocol, dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers, and/or one or more sources of remote information (e.g., GPS data, traffic information, weather information, and so on).

Turning now to FIG. 2, an exemplary environment 200 for use of a vehicle having a system for performing frequency and timing offset estimation in a bistatic radar in is shown in accordance with various embodiments A bistatic radar detection system is employed in the environment 200 including a host vehicle 215 having a system for estimating a Doppler shift and a time delay in the bistatic radar located in an environment 200 including a plurality of buildings 210-215 and a proximate vehicle 220. In some exemplary embodiments, the proximate vehicle 220 can be any non-static object, such as a bicycle, pedestrian, trailer, etc. The host vehicle 215 may be any type of vehicle. The bistatic radar detection system includes at least one transmitter 240 positioned at a known location and at least one receiver integrated into the host vehicle 215. The at least one receiver is configured to collect electromagnetic signals 255 emitted by the at least one transmitter 240. Critically, in the bistatic configuration, the one or more transmitters 240 is located remotely from the host vehicle 215 and separate from the receiver location and has no wired connection to the receiver. The transmitters 240 can be located in fixed geographical locations or can be mobile transmitters with a known location and velocity. The one or more controllers in the host vehicle have knowledge of the location of the transmitter 240 that transmits a specific multi-carrier modulation signal. In some exemplary embodiments, the one or more transmitters 240 act as the main communication point for one or more wireless mobile client devices. While only a single host vehicle 215 with receivers is shown for simplicity, multiple vehicles with receivers may be present.

In some exemplary embodiments, the transmitter 240 can be a mobile communications base station associated with a cellular identification (cell ID). The cell ID may scramble pilot tones. Upon reception, the receiver in the host vehicle 215 can detect the cell ID during an initial synchronization procedure. The cell ID assists in separating the signals from a composite signal into signals pertaining to the specific transmitter 240. The multi-carrier modulation signals 255 comply with a wireless data standard, such as 5G, but non-compliant signals may also be used. Examples of multi-carrier modulation signals 255 include OFDM and OTFS. The multi-carrier modulation signals 255 can include subcarriers with reference signals at predefined, standards-compliant frequency locations (e.g., as defined by 3GPP 5G NR know to the receiver). The signals 255 experience reflection, diffraction, and scattering, from buildings 210-214 and other static objects and are collected by the receiver in the host vehicle 215. At the host vehicle 215, the received electromagnetic signal can include multiple multipath components resulting from the transmitted signals 255 propagating via diverse combinations of reflection and diffraction events occurring at various scattering surfaces within the environment 200.

In one embodiment, applicable to both line of sight and non line of sight scenarios, utilizing a common, highly stable reference clock, often distributed via a dedicated timing link or GPS disciplined oscillators to ensures coherent processing of the received signals, enabling accurate target detection and localization despite the independent locations of the transmitter 240 and receiver 215. Furthermore, in line-of-sight scenarios, synchronization can be achieved through channel estimation by leveraging known transmitter/receiver positions and velocities to adjust frequency and timing offsets using Doppler and range estimates, respectively. For example, in bistatic radar, precise synchronization of a line of sight transmitted signal between the spatially separated transmitter 240 and receiver 215 can be achieved by measuring the frequency of the arriving signal. Exploiting knowledge of the direction of the line of sight component, and velocity and driving direction of the receiving vehicle, the Doppler shift induced by the movement can be measured directly and therefore the difference of the measured frequency at the receiver, compensated by this Doppler shift, from the measured received frequency in this line of sight component has to be the frequency offset of the receiver local oscillator. However, non-line-of-sight bistatic joint communication and sensing radar requires additional processing due to the absence of a direct path. Reflections off buildings 210-214 create indirect paths with Doppler shifts dependent on the reflection point's angle relative to the receiver, making timing estimation more challenging without precise knowledge of these reflection points. Consequently, accurate synchronization in non line-of-sight settings necessitates sophisticated techniques such as map information, ray tracing models, machine learning, and/or clutter suppression to estimate timing and frequency offsets.

A timing and frequency offset correction approach leverages multi-modal map information, ray tracing, and machine learning. Utilizing the maps commonly deployed in autonomous vehicles, the environment's geometry (receiver, building, and transmitter locations) can be extracted to estimate reflector locations. Virtual anchor and reflector locations can then be derived through analytical methods based on specular reflection, ray tracing simulations, or machine learning prediction. These reflector locations, combined with receiver velocity, enable the computation of expected multipath component range and Doppler, facilitating timing and frequency offset correction.

Range and Doppler estimation can involve several key steps. First, range migration caused by frequency offsets is corrected prior to processing the signal within a single radar processing interval, which encompasses channel estimates for a fixed number of symbols and subcarriers. Multipath component detection can then be performed using Fourier estimation or similar techniques. When the power of a multipath component exceeds a defined threshold, its range and Doppler are then estimated. Finally, the range-Doppler estimation errors are characterized as a function of the received signal-to-noise ratio.

Timing and frequency offset estimation involves associating the expected multipath component range-Doppler with the observed range-Doppler. Since there can be many multipath components in both the expected and observed range-Doppler, we have to do an association between the two sets. A variety of matching techniques might be used for this. In one embodiment, we compute the range and Doppler difference between the different pairs of observed paths. We check for the association where this difference is equal to the difference in expected paths. both A comparison between these values yields optimal timing offset and frequency offset estimates. The computed estimation errors can be used to characterize the quality of the extracted estimates. We further keep track of the trajectories traced out by all the observed paths. Once these trajectories are associated with expected trajectories has reached a certain confidence level, we declare the association is complete and we directly use the tracked trajectories of expected and observed paths to get the timing and frequency offsets. In systems with multiple antennas, the angle of arrival of multipath components can be calculated and incorporated into the association process. Comparing the expected and observed angle of arrival further enhances the robustness of the association, leading to more accurate timing offset and frequency offset correction.

A finer-grained frequency offset correction method can employ a clutter suppression technique, such as displaced phase center array (DPCA) clutter suppression technique. DPCA compares two-antenna channel estimates taken at different times, aligning the phase center of the second antenna at time 1 with the first antenna at a later time (e.g., time 2). This subtraction is performed over a single range-pulse interval, assuming a constant frequency offset within that range pulse interval. Leveraging the assumption that static targets have higher power than dynamic targets, the residual multipath component power is calculated for various hypothesized frequency offset values. The optimal frequency offset estimate is then selected as the value minimizing this residual power.

An alternative fine-grained frequency offset correction method can employ clutter suppression techniques that combine signals from multiple antennas and multiple time instants within a radar processing interval that remove the dominant reflector components if there is no frequency offset. Assuming a constant frequency offset within the processing interval, the optimal frequency offset estimate is then selected as the value minimizing this residual power.

Machine learning can be used to enhance reflector/scatterer location estimation through a training and testing paradigm. The machine learning model can be trained using data derived from ray tracing simulations or real-world measurements correlating a moving car's position with corresponding reflector/scatterer locations. Training data encompasses various scenarios, including different car types, speeds, and surrounding vehicle densities. During testing, the trained model estimates the most probable reflections from intersections in real-time. Training may be done over multiple environments, or may be for a single environment, and potentially a single section of the street, using data from the same car driving through it at earlier times, or of measurements from other cars. Furthermore, transfer learning techniques can be applied to leverage knowledge gained from training on previously encountered intersections to improve the model's performance on new, unseen intersections.

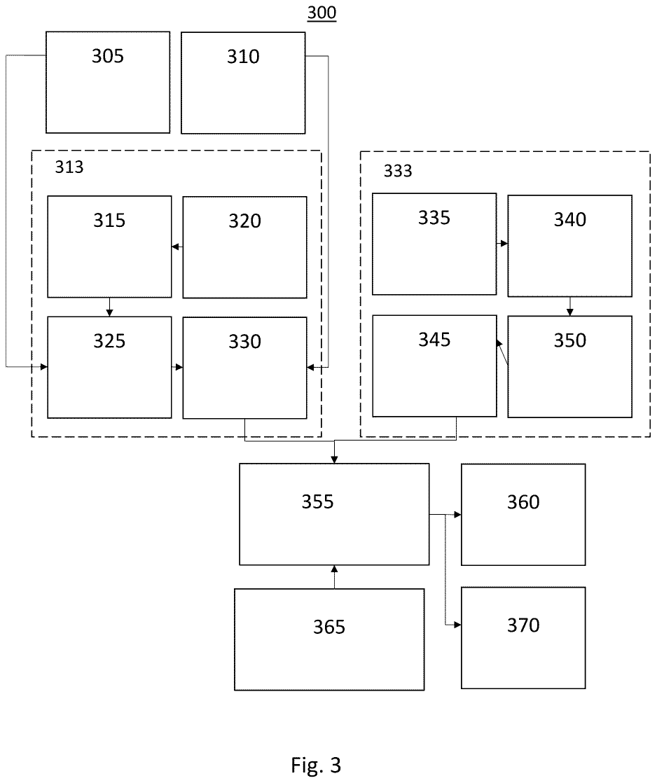

Turning now to FIG. 3, a functional block diagram illustrative of a system 300 for performing frequency and timing offset estimation in bistatic radar in accordance with various embodiments is shown. The exemplary system 300 can include a ground truth range Doppler block 313, an observed range Doppler block 333, and an association block 355.

The ground truth range-Doppler block 313 is configured to estimate an actual, measured range and velocity of objects within the proximate area of the host vehicle to determine a baseline range and velocity. The ground truth range-Doppler block 313 first retrieves high definition map data 320 for the area proximate to the host vehicle from a memory or the like. The ground truth range-Doppler block 313 then estimates the location of the transmitter, receiver and buildings within the map data. In response to the location of the transmitter, receiver and buildings within the map data, the ground truth range-Doppler block 313 then generates virtual anchor reflectors using analytical ray tracing techniques 305. Analytical ray tracing techniques 305 for radar use mathematical equations to model the paths of radar waves, calculating reflections and refractions to predict signal propagation and target detection in complex environments. Virtual anchors 325 generated in response to the analytical ray tracing algorithms are virtual locations of transmitters used to simplify the calculation of complex ray paths, enabling efficient prediction of signal propagation in environments with multiple reflections. In response to the virtual anchors, the ground truth range-Doppler block 313 generates an expected Doppler 330 corresponding to the transmitter and receiver locations. As indicated above, equivalent estimates of Doppler and runtime can be computed, in another embodiment of the invention, without explicit computation of the virtual anchors just based on the knowledge of covered signal path and directions.

The observed range Doppler block 333 is configured to processes electromagnetic signals to generate a range-Doppler map. The observed range Doppler block 333 first performs a timing drift correction 335 on the received signal. In some exemplary embodiments, in response to the received signal, the observed range Doppler block 333 calculates a preliminary range estimate based on the time delay. This estimate is then compared against the radar's maximum unambiguous range, a function of the pulse repetition frequency. If the estimated range exceeds the maximum unambiguous range, indicating ambiguity, the system selects among the several possible ranges according to other information, such as received power, and map information.

The observed range Doppler block 333 next performs a multi-path component extraction 340 on the drift corrected signal. In some exemplary embodiments, multipath component extraction can be achieved through high-resolution spectral analysis techniques, or employing Fourier-based methods. Upon receiving the signal at the receiver, data can be collected over a coherent processing interval. A Fourier transform, such as a periodogram or a more advanced technique like Capon's method or Multiple Signal Classification (MUSIC), can then be applied to this coherent processing interval data. The resulting, potentially two-dimensional, spectrum will exhibit distinct peaks corresponding to the direct path and various multipath components, each with potentially different Doppler shifts and delays. The observed range Doppler block 333 then detects the peaks 350 and performs a range Doppler estimation 345 in response to the peaks. The association block 355 identifies the observed MPC trajectories from the block 333 and check for the consistency of range-Doppler differences with the expected range-Doppler trajectories from block 313 and makes the association. The expected Doppler from the ground truth range-Doppler block 313 and the range Doppler estimation from the observed range Doppler block 333 are then compared to determining a timing offset estimation 360 and a frequency offset estimation 370. In systems with multiple antennas, the angle of arrival of multipath components from 365 can be incorporated into the association process. Comparing the expected and observed angle of arrival further enhances the robustness of the association, leading to more accurate timing offset and frequency offset correction.

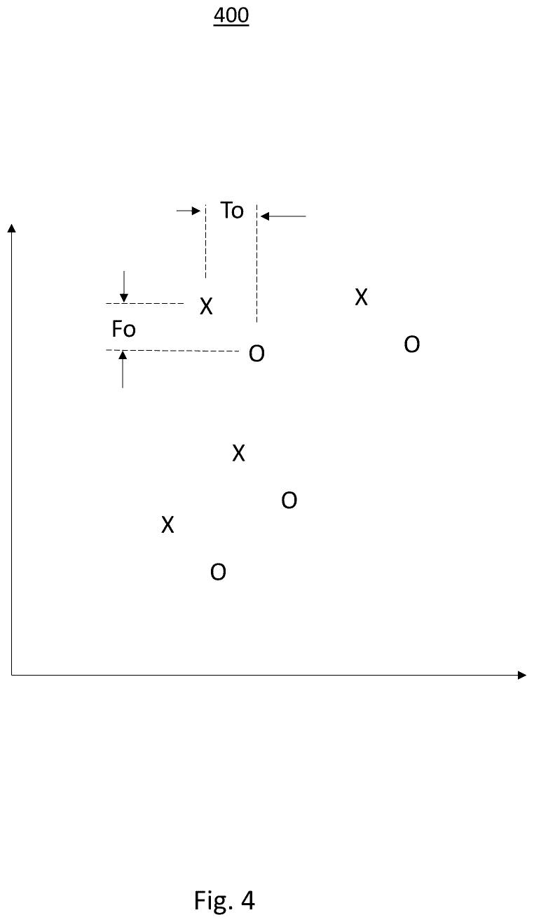

Turning now to FIG. 4, a graph 400 illustrative of a frequency and timing offset estimation in bistatic radar in accordance with various embodiments is shown. According to one or more exemplary embodiments, the graph 400 is illustrative of a plurality of observed multipath components (X) from the observed range Doppler block 333 of FIG. 3 versus a plurality of ray tracing multipath components (O) from the ground truth range-Doppler block 313 of FIG. 3. The difference between the observed multipath components (X) and the ray tracing multipath components (O) is the timing offset (To) and the frequency offset (Fo). In some exemplary embodiments, the timing offset (To) and the frequency offset (Fo) can be estimated in response to an average or mean of the individual offsets for each of the observed multipath components. As can be seen from the graph 400, the timing offset (To) and the frequency offset (Fo) for each of the multipath components is consistent. These determined timing and frequency offsets can then be applied to signals reflected from non-static objects non included on the map data. For example, if a received signal has a signal path indicative of an object in a roadway, the exemplary system can apply the determined frequency and timing offsets for tracking the object.

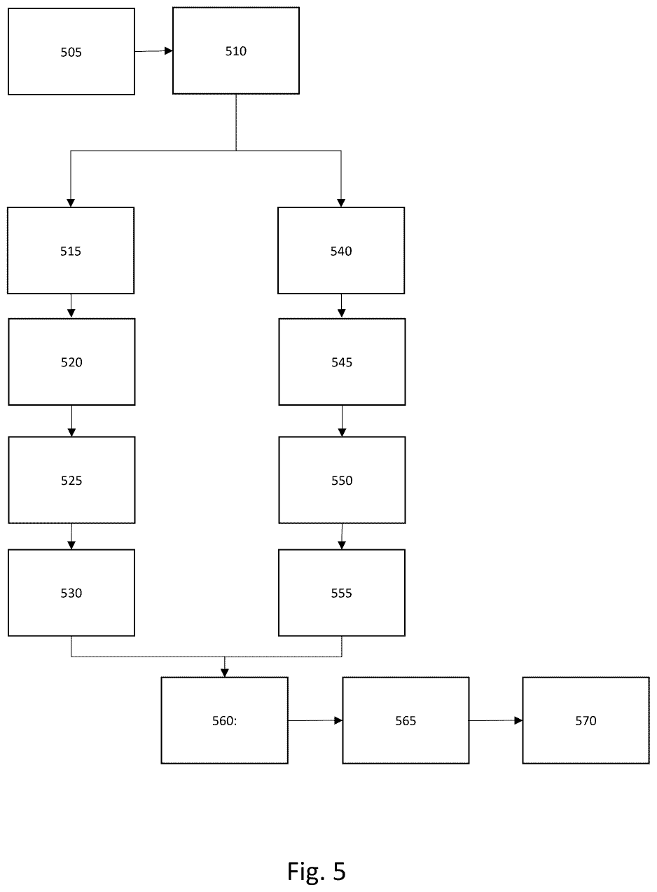

Turning now to FIG. 5, a flow chart illustrative of a method 500 for performing frequency and timing offset estimation in bistatic radar in accordance with various embodiments is shown. The method 500 is first operative to receive 505 at least one electromagnetic signal. In some exemplary embodiments, the electromagnetic signal can be a specific multi-carrier modulation signal transmitted from a cellular base station and used as a transmission channel for wireless communications between the base station and one or more wireless mobile client devices. In some exemplary embodiments, the electromagnetic signal can include data indicative of an identification or the cellular base station and/or a location of the transmitter. The data can further include a velocity of the transmitter if the transmitter is a mobile transmitter. In some cases the data are payload data that-after decoding by the receiver-are known, and can then be used in the same manner as reference signals.

The method 500 is next operative to determine 510 a location and velocity of the receiver. The location of the receiver can be determined in response to data received from a global navigation satellite system or the like or other location determining source located within a vehicle and wherein the location is transmitted to the receiver from the location determining source via a controller area network bus or the like.

In response to the transmitter location and the receiver location, the method 500 is next operative to retrieve 515 a map data including the transmitter location and the receiver location. In some exemplary embodiments, this map data can be high definition map data. High-definition map data possesses centimeter-level accuracy and incorporate rich semantic information. Key components can include a highly detailed three dimensional point cloud representation of the environment, generated via LiDAR or photogrammetry, providing precise geometric information about static objects like road markings, curbs, signs, and buildings. This geometric data is augmented with a vectorized road network representation, defining lane boundaries, connectivity, and traffic rules. High definition maps also can encode dynamic information, such as traffic light locations and states, and may incorporate real-time updates regarding construction zones or temporary road closures. In some exemplary embodiments, assisted driving vehicles can leverage the semantic information within the high definition map for robust perception and prediction, enabling the vehicle to determine the vehicle location within the map in response to other vehicle sensor data, such as radar, LiDAR and/or imaging data.

Using the maps and the transmitter and receiver locations, the method 500 next generates 520 virtual anchor reflector locations. A virtual anchor, also known as the iso-range ellipse's tangent point, represents the apparent origin of the reflected signal as perceived by the receiver. Determining this virtual anchor requires knowledge of the transmitter position, as well as the bistatic range (the sum of the distances from the transmitter to the target and from the target to the receiver). Accurate estimation of the virtual anchor can be made using object locations, such as building surfaces, light posts, etc., described by the three dimensional map data. The virtual anchors serve to allow a more intuitive localization, but using the information about bistatic range and angles of the multipath components can be employed for the subsequent tasks without explicitly computing virtual anchor locations, which is included as another embodiment of the invention.

The method 500 is next operative to perform ray tracing operations to estimate signal paths from the transmitter to the receiver reflected from the environmental objects. Ray tracing techniques such as the shooting and bouncing method or the image method, are used to model the non-line-of-sight propagation paths inherent in bistatic radar. These algorithms can account for the bistatic angle, terrain profile, and electromagnetic properties of reflecting surfaces to predict signal time delay and angle of arrival at the receiver. The process involves launching rays from the transmitter and simulating their interactions, such as reflection and diffraction, with the surrounding environment, tracking their trajectories until they reach the receiver. Subsequently, the received signal strength and phase can be calculated based on the cumulative path length and reflection coefficients at each interaction point along the ray's trajectory. The method 500 next estimates expected multipath component at the receiver based on the various ray traced signal paths.

In response to the transmitter location and the receiver location, the method 500 is further operative to perform range mitigation corrections on the received signals. Range mitigation correction in bistatic radar can be used to compensate for the timing drift due to the frequency offsets. The method 500 next extracts the observed multipath components from the corrected received signal. Signal processing techniques, such as serial interference cancellation or adaptive filtering or subspace-based methods, which leverage differences in arrival time, angle of arrival, and polarization can be used to distinguish and separate the desired path signal from the undesired reflected paths arriving via various environmental scatterers.

The method 500 next detects peaks from the desired signal path. In some exemplary embodiments, a bistatic radar receiver can identify signal path peaks by employing matched filtering or pulse compression techniques to correlate the received signal with a replica of the transmitted waveform, followed by peak detection algorithms to analyze the correlator output to identify maxima exceeding a predetermined threshold, thereby distinguishing the desired signal path from noise and multipath interference. The method 500 then generates 555 observed multipath components in response to the detected peaks. In another embodiment, the signal contributions from the already-detected peaks can be subtracted from the received signal to allow a more accurate extraction of the remaining peaks. In yet another embodiment, the detection and subtraction can be refined iteratively.

To determine the frequency and timing offsets 565, the method 500 next compares 560 the ray tracing and observed multipath components. The differences in frequency and time can be used as frequency and timing offsets for bistatic radar detection and tracking of dynamic and/or non-static objects detected within the three dimensional map area. In some exemplary embodiments, such as when deployed in a vehicle with an advanced driving assisted system, the frequency and timing offsets, and the locations and velocities of the dynamic objects can be used in generating a motion path to control 570 the vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A radar receiver comprising:
a memory configured to store a map data;
a location configured to determine a receiver location and a receiver velocity;
a receiver configured to receive a first electromagnetic signal including a data indicative of a transmitter identification;
a signal processor configured to extract an observed multipath component from the first electromagnetic signal and for generating an observed frequency and an observed timing for the observed multipath component;
a numerical processor configured for performing a ray tracing algorithm in response to the map data, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing, wherein the receiver is further operative to detect a location of a dynamic object and a velocity of the dynamic object in response to the transmitter location, the receiver location, the receiver velocity, the frequency offset, the timing offset and the map data; and
a vehicle controller configured to generate a motion path in response to the location of the dynamic object and the velocity of the dynamic object and for controlling a vehicle along the motion path.

2. The radar receiver of claim 1 wherein the numerical processor is further operative to receive a subsequent electromagnetic signal having a subsequent timing and a subsequent frequency, being further operative and wherein the receiver is further operative to detect a location of a dynamic object and a velocity of the dynamic object in response to the subsequent frequency and the subsequent timing.

3. The radar receiver of claim 1 wherein the numerical processor is further configured to determine a plurality of reflector locations in response to the map data and at least one of a plurality of virtual anchor reflector locations in response to a building wall location included in the map data.

4. The radar receiver of claim 1 wherein the dynamic object is a proximate vehicle and wherein the location of the proximate vehicle is determined in response to the proximate vehicle being located on a road surface as defined by the map data.

5. The radar receiver of claim 1 wherein the transmitter identification is indicative of a transmitter and wherein the transmitter is a cellular base station and wherein the first electromagnetic signal and the subsequent electromagnetic signal are cellular communication signals.

6. The radar receiver of claim 1 wherein the numerical processor is further operative to determine an angle of arrival of the first electromagnetic signal in response to the first electromagnetic signal received at a first antenna at a first location on the vehicle and the first electromagnetic signal received at a second antenna at a second location on the vehicle.

7. The radar receiver of claim 1 wherein the expected multipath component includes an expected Doppler shift.

8. The radar receiver of claim 1 wherein the observed multipath component includes an observed Doppler shift.

9. The radar receiver of claim 1 wherein the transmitter identification includes the transmitter location.

10. A method of controlling a radar receiver comprising:
storing, in a memory, a map data including a transmitter location;
determining, by a location sensor, a receiver location and a receiver velocity;
receiving, by an antenna, a first electromagnetic signal including a data indicative of the transmitter location;
extracting, by a signal processor, an observed multipath component from the first electromagnetic signal, and detecting an observed frequency and an observed timing for the observed multipath component;
determining, by a numerical processor, a plurality of reflective surface locations in response to the map data, the transmitter location and the receiver location;
performing, by the numerical processor, a ray tracing algorithm in response to the plurality of reflective surface locations, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing;
determining, by the numerical processor, a location of a dynamic object and a velocity of the dynamic object in response to the transmitter location, the receiver location, the receiver velocity, the frequency offset, the timing offset and the map data; and
generating, by a vehicle controller, a motion path in response to the location of the dynamic object and the velocity of the dynamic object and for controlling a vehicle along the motion path.

11. The method of controlling the radar receiver of claim 10, wherein the motion path is further generated in response to the map data.

12. The method of controlling a radar receiver of claim 10, wherein the location of the dynamic object and the velocity of the dynamic object are determined in response to a Doppler shift greater than a range of Doppler shifts corresponding to a plurality of static objects indicated within the map data.

13. The method of controlling the radar receiver of claim 10, further including determining a plurality of virtual anchor locations in response to a combination of ray tracing techniques, specular reflection, and machine learning algorithms trained with ray tracing data and measurements of intersections and corresponding reflector locations.

14. The method of controlling the radar receiver of claim 10, further including performing a timing drift correction due to the frequency offset by the signal processor.

15. The method of controlling the radar receiver of claim 10, wherein the extracting of the observed multipath component further includes using at least one of a Fourier estimation and a super-resolution algorithm.

16. The method of controlling the radar receiver of claim 10, wherein the observed frequency and the observed timing for the observed multipath component are extracted in response to the observed multipath component exceeding a threshold magnitude.

17. The method of controlling the radar receiver of claim 10, wherein the antenna is an antenna array having a first antenna element and a second antenna element and wherein the signal processor is further configured to determine an angle of arrival of the first electromagnetic signal in response to the first electromagnetic signal received at the first antenna element and a second phase of the first electromagnetic signal received at the second antenna element.

18. The method of controlling the radar receiver of claim 17, further including performing a clutter suppression technique on the first electromagnetic signal received at the first antenna element at a first time and a second electromagnetic signal received at the second antenna element at a second time.

19. A vehicle comprising:
a radar receiver configured to:
storing, in a memory, a map data including a transmitter location;
determine, by a location sensor, a receiver location and a receiver velocity;
receive, by an antenna, a first electromagnetic signal including a data indicative of the transmitter location;
extract, by a signal processor, an observed multipath component from the first electromagnetic signal and for generating an observed frequency and an observed timing for the observed multipath component;
determine, by a numerical processor, a plurality of reflector locations in response to the map data, the transmitter location and the receiver location;
perform, by the numerical processor, a ray tracing algorithm in response to the plurality of reflector locations, the transmitter location and the receiver location to extract an expected multipath component having an expected frequency and an expected timing and for determining a frequency offset in response to a difference between the expected frequency and the observed frequency and a timing offset in response to a difference between the expected timing and the observed timing;
determine, by the numerical processor, a location of a dynamic object and a velocity of the dynamic object in response to the transmitter location, the receiver location, the receiver velocity, the frequency offset, the timing offset and the map data; and
a vehicle controller configured to:
generate a motion path in response to the location of the dynamic object and the velocity of the dynamic object; and
controlling the vehicle along the motion path.

20. The vehicle of claim 19, wherein the antenna is an antenna array having a first antenna element and a second antenna element and wherein the signal processor is further configured to determine an angle of arrival of the first electromagnetic signal in response to the first electromagnetic signal received at the first antenna element and a second phase of the first electromagnetic signal received at the second antenna element, and for performing a displaced phase center antenna clutter suppression technique on the first electromagnetic signal received at the first antenna element and the first electromagnetic signal received at the second antenna element, and wherein the location of the dynamic object and the velocity of the dynamic object are determined in response to a Doppler shift greater than a range of Doppler shifts corresponding to a plurality of static objects indicated within the map data.
